(19) United States
(12) Patent Application Publication
(10) Pub. No.: US 2002/0123844 A1
(43) Pub. Date: Sep. 5, 2002

(54) Method and system for locating mineral deposits

(76) Inventor: Ricardo A. Valls, Toronto (CA)

Correspondence Address: Mr. Ronald H. Joachim, c/o Ridout & Maybee, Suite 2400, One Queen Street East, Toronto, ON, M5C 3B1, CA

(21) Appl. No.: 09/750,274

(22) Filed: Dec. 29, 2000

(51) Int. Cl. G06F 19/00

(52) U.S. Cl. 702/5

(57) ABSTRACT

A method and a system for locating mineral deposits which utilizes readily available data and is performed using a computer without the need for on-site exploration of the area of interest. The method comprises (a) gathering data relevant to the existence of the mineral deposit within the area of interest; (b) analyzing said data and identifying a plurality of parameters present in said data; (c) dividing the area of interest into a grid comprised of a plurality of grid elements; (d) assigning a numerical value for each said parameter to each said grid element in said area of interest; (e) calculating a plurality of correlation values, each one of said correlation values comprising a numerical value representative of a strength of a positive or negative correlation between one pair of said parameters over said area of interest; (f) analyzing the correlation values to identify a correlation relationship between a subset of said plurality of parameters which show strong positive or negative correlations to one another; (g) determining whether or not the correlation relationship is consistent with the data gathered for the area of interest; and (h) where the correlation relationship is consistent with the data, identifying potential mineralized zones within said area of interest where the relationship between the parameters is consistent with the correlation relationship; or (i) where the correlation relationship is not consistent with the data, returning to said step (f).

### FIELD OF THE INVENTION

This invention relates to location of mineral deposits and, more specifically, relates to a computer-assisted method and system for ore prospecting.

### BACKGROUND OF THE INVENTION

Prospecting for mineral deposits typically involves exploring an area of interest to gather and analyze a number of types of data, including seismic, geochemical, geological and geophysical data. prospecting is becoming ever more difficult and expensive as most near-surface mineral deposits have already been found.

Thus, there exists a need for a more economical and effective method of prospecting for mineral deposits.

### SUMMARY OF THE INVENTION

The present invention overcomes the disadvantages of the prior art by providing a method and a system for locating mineral deposits which utilizes readily available data and which can be performed using a computer, without the need for on-site exploration of the area of interest.

According to one aspect, the present invention provides a method for locating a mineral deposit in an area of interest, comprising:

(a) gathering data relevant to the existence of the mineral deposit within the area of interest;

(b) analyzing said data and identifying a plurality of parameters present in said data;

(c) dividing the area of interest into a grid comprised of a plurality of grid elements,

(d) assigning a numerical value for each said parameter to each said grid element in said area of interest;

(e) calculating a plurality of correlation values, each one of said correlation values comprising a numerical value representative of a strength of a positive or negative correlation between one pair of said parameters over said area of interest;

(f) analyzing the correlation values to identify a correlation relationship between a subset of said plurality of parameters which show strong positive or negative correlations to one another;

(g) determining whether or not the correlation relationship is consistent with the data gathered for the area of interest., and

(h) where the correlation relationship is consistent with the data, identifying potential mineralized zones within said area of interest where the relationship between the parameters is consistent with the correlation relationship; or

(i) where the correlation relationship is not consistent with the data, returning to said step (f).

In another aspect, the present invention provides a system for locating a mineral deposit in an area of interest, comprising:

(a) data gathering means for gathering data relevant to the existence of the mineral deposit within the area of interest;

(b) first data analysis means for analyzing said data and identifying a plurality of parameters present in said data;

(c) first data tabulating means for tabulating numerical values of said plurality of parameters over said area of interest, wherein said area of interest is divided into a grid comprised of a plurality of grid elements and each said parameter is assigned a numerical value for each said grid element;

(d) data processing means for calculating a plurality of correlation values, each one of said correlation values comprising a numerical value representative of a strength of a positive or negative correlation between one pair of said parameters over said area of interest;

(e) second data analysis means for analyzing the correlation values and identifying a correlation relationship between a subset of said plurality of parameters which show strong positive or negative correlations to one another; and

(f) comparing means to determine whether or not the correlation relationship is consistent with the data gathered for the area of interest.

### BRIEF DESCRIPTION OF THE DRAWINGS

The invention will now be described, by way of example only, with reference to the accompanying drawings, in which:

FIG. 1 is a flow chart illustrating the steps involved in preferred embodiments of the method of the present invention;

FIG. 2 is a portion of a map showing the results of a lineament study according to a preferred method of the present invention;

FIG. 3 illustrates a portion of a table containing the lineament data of FIG. 2;

FIG. 4 illustrates a portion of a table containing the results of a correlation analysis conducted with the data contained in the table of FIG. 3;

FIG. 5 illustrates the portion of the table of FIG. 4 after elimination of weak positive and negative correlations;

FIG. 6 illustrates a table in which the strong and medium correlations are ranked from strongest positive to strongest negative correlation, and which includes values for the corresponding distances between a pair of parameters;

FIG. 7 illustrates a method by which parameters are plotted according to the invention:

FIG. 8 illustrates a plot of the distances shown in FIG. 6; and

FIG. 9 schematically illustrates a preferred apparatus according to the invention.

### DETAILED DESCRIPTION OF PREFERRED EMBODIMENTS

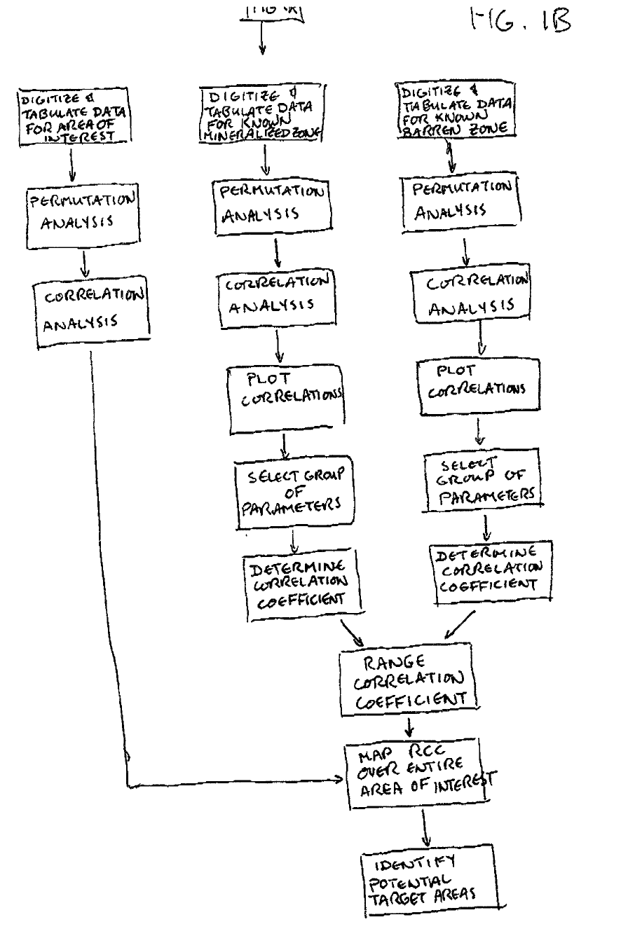

The use of the method of the present invention to locate mineral deposits in a predetermined area of interest is now discussed in detail below. The flow chart of FIG. 1 is illustrative of the steps followed in the first preferred embodiment of the invention.

Firstly, the area of interest is identified and its coordinates determined. The area of interest is not particularly limited in size, although the method tends to produce more reliable results for large areas than for small areas. The size of an area of interest usually ranges from about 15 km² to about 14,000 km², more typically from about 350 km² to about 1,500 km². Preferably, the area of Interest has an area of at least about 500 km² for a study at scale 1:25,000.

Next, preliminary research is performed to gather data relating to the area of interest. Such data may preferably comprise pre-existing, publicly available data, or may be specially generated for the specific prospecting operation in question. The data consists of information which is relevant to the existence of mineral deposits in the area of interest. Such data includes topographic maps, aerial photographs, satellite photographs, mining claim maps, digital elevation models, geological maps, drilling results and geophysical, geochemical, hydrogeological, geomorphological, biogeochemical and geobotanical data. It may not be possible to obtain all these types of data for each area of interest.

For reasons discussed in more detail below, the method of the invention can be successfully applied where the only information available consists of topographical maps, typically available from the government, and aerial or satellite photographs. However, it is preferred that the data also include information as to the location of at least one known mineralized zone and at least one known barren (non-mineralized) zone within the area of interest. The locations of known mineralized and barren zones can typically be determined from mining claim maps, from topographic maps showing the location of present or former mines, or from geological, geophysical or geochemical data.

The first example described below describes a typical analysis where the data does not include information as to the location of known mineralized and barren zones in the area of interest.

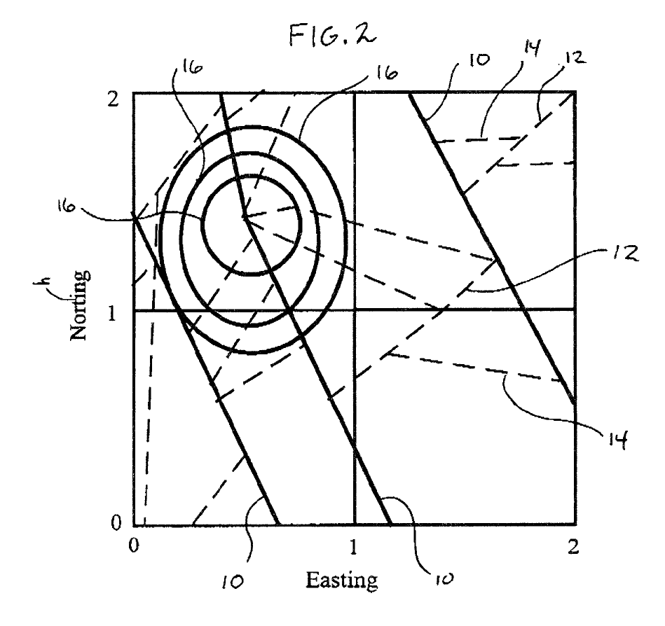

The next step in the method of the invention is to conduct a lineament study of the area of interest using the gathered data, and specifically topographic maps and any aerial and satellite photographs which may be available. Lineaments are linear or circular topographical features which reflect the location of subsurface phenomena associated with the existence of mineral deposits, for example jointing patterns, faults, etc. The existence of a relatively high density of lineaments in a given area usually indicates the existence of a mineral deposit in that area. FIG. 2 is illustrates the results of a typical lineament study which, for simplicity, shows only a minor portion of the area of interest.

After mapping the lineaments in the area of interest, the lineaments are then classified as to type. Lineaments can be classified as circular, first order, second order, third order, etc, A first order (main) lineament is one which intersects other lineaments without being broken. That is, it is continuous through points of intersection with other lineaments. A second order lineament is one which is broken only by first order lineaments. A third order lineament is one which is broken by first order and second order lineaments. Although fourth, fifth, sixth and lower order lineaments may be present in an area of interest, it is typically not necessary to go lower than the third order. In FIG. 2, examples of first order lineaments are identified by reference numeral 10, second order by 12, third order by 14 and circular by 16.

Next, the results of the lineament study and other available geological, geochemical and geomagnetic data are converted to digital form and entered into a computer. in order to digitize the data, the area of interest is subdivided into a grid comprising an array of grid elements of identical size, each of which may, for example, represent an area of about 1 km². Each grid element is assigned a unique identifier. For example, the portion of the area of interest shown in FIG. 2 comprises a total of four grid elements. Each grid element in FIG. 2 is identified by an X coordinate and a Y coordinate and may have an area of 1 km². As mentioned above, the area of interest may preferably have an area of at least 500 km². Therefore, such a map of the entire area of interest may comprise a grid of 500×500 grid elements.

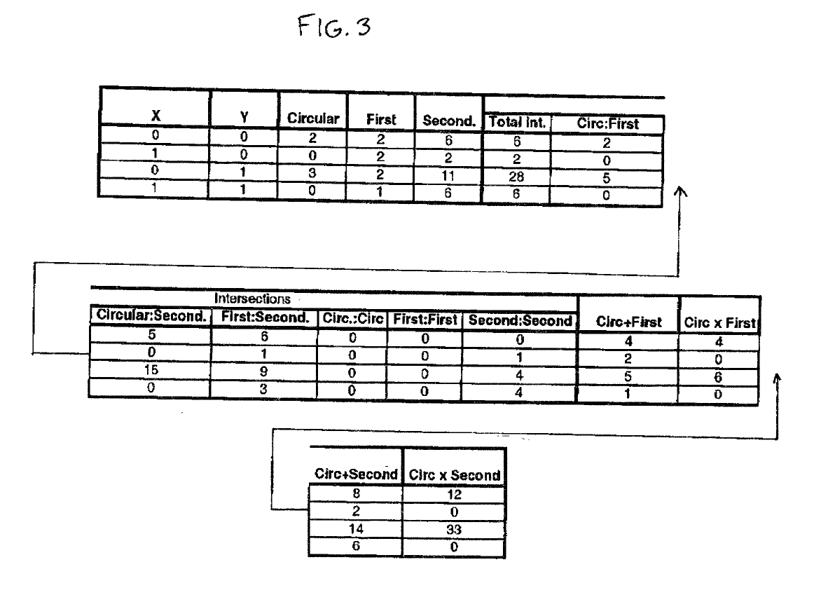

The results of the lineament study are digitized by superimposing the grid described above on the lineament map of the area of interest as shown in FIG. 2 and assigning a unique identifier to each type of lineament. In each of the grid elements, the numbers of each type of lineament, or portions thereof, are counted. The numbers and types of intersections between the lineaments are also counted for each grid element. The results of this analysis are input into a computer and tabulated in a database, for example using Microsoft Excel software, The table has dimensions equal to the number of grid elements by the number of parameters, with each type of lineament or intersection comprising a unique parameter, FIG. 3 illustrates the results of data tabulation for the four grid elements shown in FIG. 2, from which lineaments of third and lower order are eliminated from consideration.

The other data relating to the area of interest are similarly processed and entered into the database table (not shown in drawings). For example, geochemical data may be available showing what specific elements or minerals are present at one or more locations within the area of interest. To digitize this data, each element and/or mineral is assigned a unique identifier and the existence or non-existence of each element or mineral is determined for each grid element for which geochemical data is available. The results of this analysis are then combined in the same table with the lineament data described above, with each element or mineral comprising a unique parameter.

A geophysical map of the area of interest may contain different colours indicative of areas of differing intensities. Each colour on the map is assigned a unique identifier and the existence or non-existence of each colour is determined for each grid element in the area of interest. The results of this analysis are also tabulated with the lineament data as described above.

The next step in the method comprises pre-modelling of the digital data contained in the database. Pre-modelling comprises statistical analysis, discriminant analysis and regional trend analysis. The statistical analysis determines the presence of statistical outliers, distribution law, mean, standard deviation, variability, range, modes, median, etc. The discriminative analysis is done to study the internal structure of the data and is done primarily with histograms and analogy tests such as the Student and Fisher tests. The regional trend uses software such as SURFER and Arc View to study the tendencies in the distribution of parameters.

Following the pre-modelling step, a permutation analysis is preferably performed. The permutation analysis involves the creation of all possible combinations of individual parameters in the database. The individual parameters are combined by multiplying and adding all possible combinations of parameters for each grid element. Each of these combinations of the individual parameters then becomes an additional parameter (referred to herein as a “combined parameter”) in the tabulated data. For example, where the originally tabulated data includes individual parameters A, B and C, the permutation analysis creates the following combined parameters:

| | |
|---|---|
| A + B | A × B |
| A + C | A × C |
| B + C | B × C |
| A + B + C | A × B × C |

Thus, in this example, the permutation expands the number of parameters in the tabulated data from three parameters to eleven parameters.

For the example shown in the attached drawings, the database table illustrated in FIG. 3 also includes a few combined parameters (Circ+First; Circ×First; Circ+Second; Circ×Second) generated by combining the individual parameters (Ciro., First, Second and the various intersections). However, it will be appreciated that many additional combinations are possible, and that the number of combinations has been limited for simplicity only.

Next, a correlation analysis is conducted to determine how each parameter in the database behaves in relation to each of the other parameters. For example, the correlation (r) between parameters X and Y is calculated as follows:

r=(Xᵢ−Mₓ)(Yᵢ−M_{y})/((n−1)SₓS_{y})

where,

r is the calculated correlation value for parameters X and Y over the entire grid;

Xᵢ is the value of parameter X for the ith grid element;

Mₓ is the average value of parameter X over all the grid elements;

Yᵢ is the value of parameter Y for the ith grid element;

M_{y} is the average value of parameter Y over all the grid elements;

n is the number of data points for X and Y;

Sₓ is the standard deviation for the parameter X; and

S_{Y} is the standard deviation for the parameter Y.

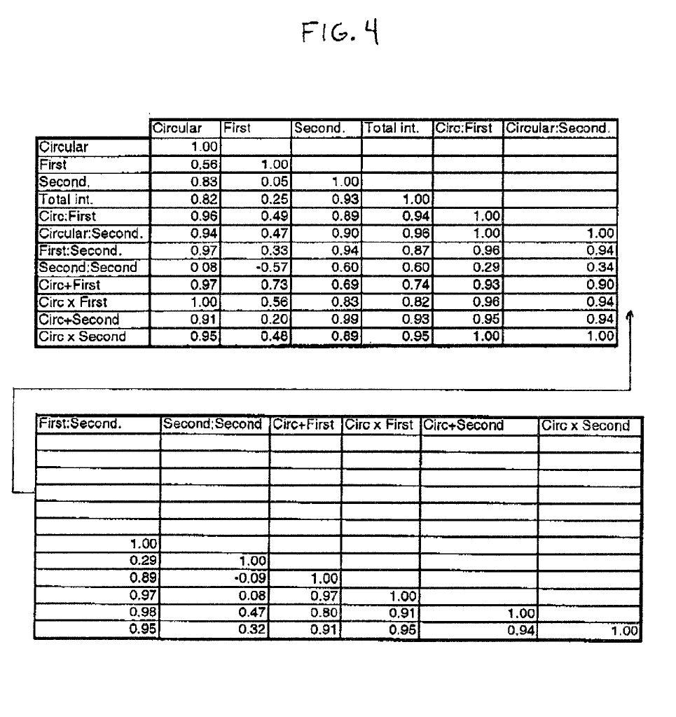

In the example shown in the drawings, FIG. 4 illustrates the results of the correlation analysis for the area of FIG. 2 in tabular form, and comprises values for correlations for every possible pair of parameters.

After calculation of the correlations for each pair of parameters, the correlations are sorted in descending order from the strongest positive correlation to the strongest negative correlation. The value of the strongest possible positive correlation between any two parameters is +1 and the value of the strongest possible negative correlation is −1, while the value of the weakest possible correlation is zero. The correlation values are then divided into five equal groups as follows:

Strong positive correlations

Medium positive correlations

Weak correlations

Medium negative correlations

Strong negative correlations

In a typical analysis according to the invention, the strong positive correlations are those with R >0.8 and medium positive correlations have 0.4 <R <0.8. Similarly, strong negative correlations may typically have R <−0.8 and medium negative correlations have −0.4 >R >−0.8. Therefore, the group which shows weak correlations would have −0.4 <R <0.4, and includes both weak positive and weak negative correlations. However, it will be understood that these numerical values are provided by way of example only, and that the actual values of the correlations would differ for each analysis, depending on the average strengths of the correlations.

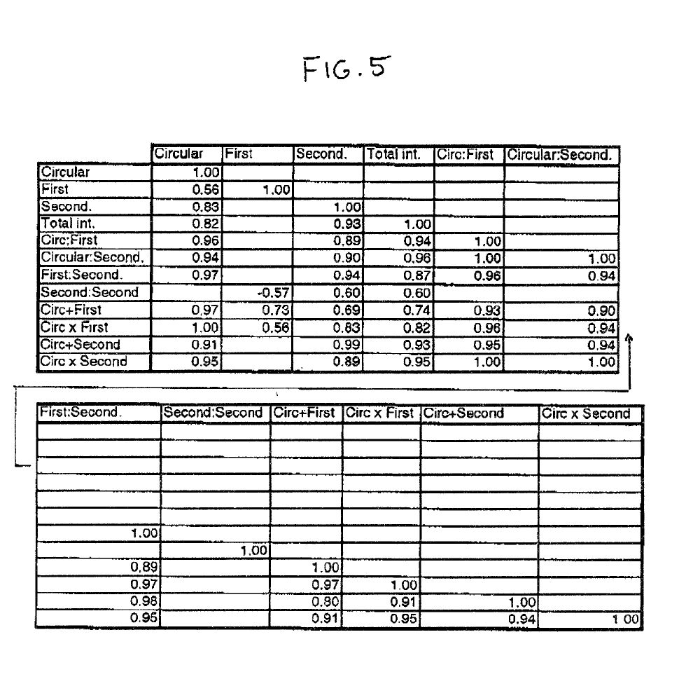

In the example shown in the drawings, FIG. 5 represents a table which is derived from the table of FIG. 4 and from which the weak correlations have been eliminated. In this example, weak correlations are those having values greater than −0.56 and less than 0.56.

Having now ranked the correlations in terms of strength, the next step involves constructing graphical representations of the medium and strong correlations only, with the weak correlations being eliminated from consideration. The strong and medium correlations are then represented graphically by a method developed by the inventor.

Firstly, the correlations are converted to “distances” by the following equation:

Lᵢ=n+(1 −(rᵢ/rₘₐₓ))

where Lᵢ is the calculated “distance” between the ith pair of parameters, n is the minimum distance between any pair of parameters (for example 4 cm), rᵢ is the correlation value for the ith pair of parameters, and rₘₐₓ is the maximum correlation between any pair of parameters. Thus, where n is 4 cm, the value of L can vary between 4 for the strongest possible positive correlation (r=+1), to infinity for the weakest possible correlation (r=0), and to 6 for the strongest possible negative correlation (r=−1).

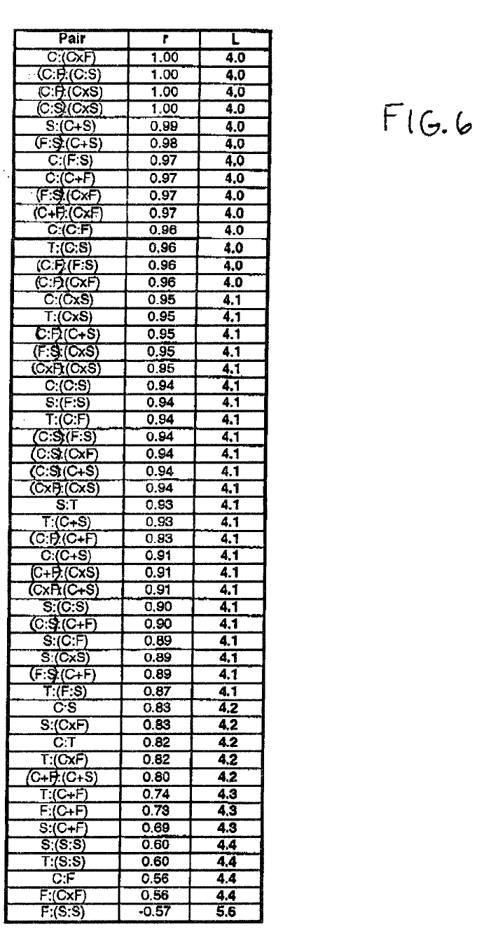

FIG. 6 shows the strong and medium correlations from FIG. 5 listed in descending order with the corresponding value of L for each correlation.

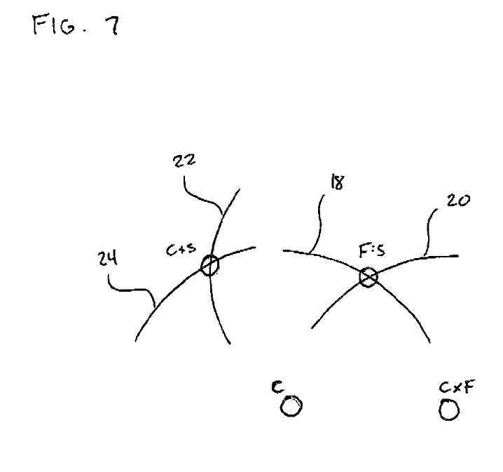

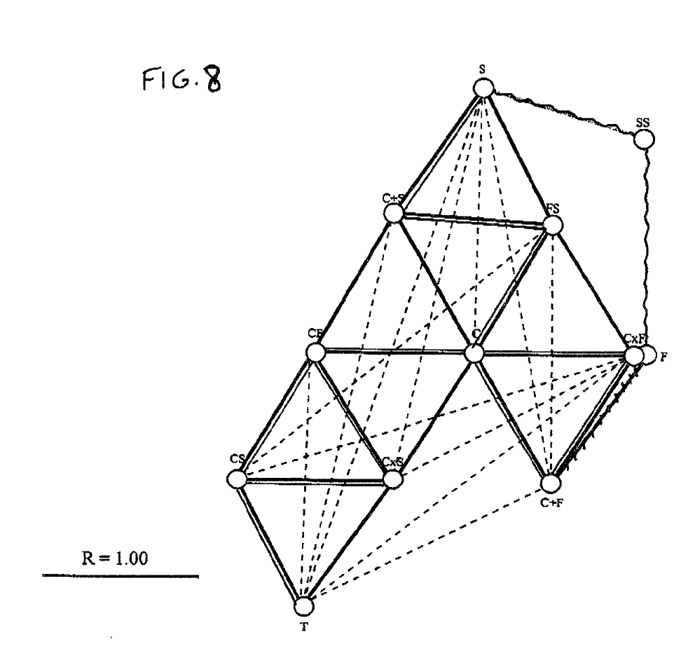

After converting the correlations to distances, the parameters are then plotted relative to one another. FIG. 8 illustrates a completed plot of the parameters for the data shown in FIG. 6, and FIG. 7 illustrates the steps involved in creating the plot shown in FIG. 8. These steps are now described below with reference to FIG. 7.

Preferably, the parameters showing the strongest positive correlations are plotted first In this example, the first pair of parameters listed in FIG. 6 is C and (C×F), with C representing the number of circular lineaments and (C×F) representing a combined parameter obtained by multiplying the circular and first order lineaments. As shown in FIG. 7, these two parameters are plotted at a separation of 4.0 cm, the shortest possible distance between any two parameters.

Having plotted the first two parameters, a third parameter is selected by going down the list in FIG. 6 until a parameter is located which correlates with either C or (C×F). The first parameter with this characteristic is F:S, which is contained in the parameter pair C;(F:S), the seventh entry in the table of FIG. 6. The distance between C and F:S is 4.0 cm. Therefore, an arc 18 of radius 4 cm is drawn about point C on the plot. Next, an arc 20 is drawn about point (C×F) on the plot having a radius of 4.0 cm, equal to the distance between F:S and (C×F) as shown by the ninth pair of parameters listed in the table of FIG. 6. parameter F:S is then plotted at the point of intersection of arcs 8 and 20.

This process is repeated by locating the first parameter listed in FIG. 6 which correlates with one of the parameters already plotted. This is (C+S), which is paired with F:S in the sixth pair of parameters listed in FIG. 6. parameter (C+S) is plotted by first drawing an arc 22 of radius 4.0 cm about parameter F:S and locating the first appearance of parameter (C+S) paired with another of the already plotted parameters, which is C,(C+S), the thirtieth entry in the table of FIG. 6. An arc 24 of radius 4.1 cm is drawn about parameter C and parameter (C+S) is plotted at the intersection of arcs 22 and 24.

The above process is repeated until all the parameters shown in FIG. 8. a are plotted. To further clarify which parameters are linked by strong correlations, lines are preferably drawn between the plotted parameters as illustrated in FIG. 8. These lines may preferably have different colours or other distinctions to assist in identifying strong correlations, In the example shown in FIG. 8, double lines join parameters separated by the minimum spacing of 4.0 cm, single lines join parameters separated by 4.1 cm, hatched lines join parameters separated by 4.2 to 4.3 cm, and wavy lines join parameters separated by more than 4.3 cm. The dashed lines represent weaker correlations between parameters which intersect the solid lines representing stronger correlations. These dashed lines are of little importance in determining the relationship of the parameters for the area of interest.

Once the parameters have been plotted as illustrated in FIG. 8, the next step in the process comprises the selection of one or more groups of parameters from the plot of parameters which correlate strongly with one another. The plot of FIG. 8 is typical in that it Shows the existence of two strongly correlated groupings, a first group (at the lower left of FIG. 8) comprising parameters C:F, C:S, C×S and T, and a second group (above and to the right of the first group) comprising parameters C, C+F, C×F, F:S, S and C+S.

One of these groups of parameters is selected and a relationship between the parameters (referred to herein as the “correlation coefficient”) is written as follows:

[S×(C+S)×C×(C+F)×(C×F)×(F:S)]/(S:S)

or

[S+(C+S)+C+(C+F)+(C×F)+(F:S)]/(S:S)

Parameter (S:S) is placed in the demoninator due to the fact that it correlates negatively with at least one of the parameters in the numerator.

Alternatively, the above expressions can be shortened to the following:

[S×(C×F)×(F:S)]/(S:S)

or

[S+(C×F)+(F;S)]/(S:S)

by eliminating those parameters which do not show a strong negative correlation with (S:S).

The above correlation coefficients represent the integrated effect of all the parameters at the same time and, assuming the correct group of parameters was selected from the plot of FIG. 8, represents an anomalous relationship of parameters which one would expected to see in a mineralized zone within the area of interest.

The next step is to apply the correlation coefficients to the area of interest and locate other zones where the relationship of parameters is consistent with the correlation coefficient. Once such zones are identified, they can then be transferred to a map of the area of interest to represent potential mineralized areas and the location of these areas is compared with other known data for the area of interest. Where the areas mapped by the correlation coefficient coincide with highly tectonic zones and geological contacts, etc., it is likely that the correct group of parameters has been selected. In addition, where the selected group of parameters includes a parameter known to be directly related to the existence of an ore deposit, for example the concentration of an element which is to be mined or, in the context of the present example, parameter C which corresponds to circular lineaments, then it is likely that this group of parameters will yield the correct correlation coefficient.

Should the selected group of parameters not be consistent with the other relevant data, then it is likely not the correct group of parameters and another group is selected which, in the present example, would be the group comprising C:F, C:S, C×S and T.

Once the correct correlation coefficient is determined, a map of the area of interest is generated which indicates the location of the potential target areas.

The following is a description of a second preferred embodiment of the invention in which the gathered data contains information as to the location of at least one known mineralized zone and at least one known barren zone within the area of interest.

The data gathering and analysis steps in the second preferred embodiment are the same as in the first embodiment described above, with the data analysis including a lineament study for the entire area of interest. After analyzing the data, it is then converted to digital form and entered into a computer. As in the first embodiment, a database table is created for the entire area of interest, as in FIG. 3.

In addition, separate database tables are created for the known mineralized zone and for the known barren zone. Specifically, the known mineralized zone is divided into a grid comprising an array of grid elements of identical size, each of which is assigned a unique identifier. All the data relevant to this particular mineralized zone, including lineament data, geophysical and geochemical data, is then analyzed as described above and is tabulated in a computer database in the same manner described above. This process is repeated for the known barren zone.

Where an area of interest contains more than one known mineralized zone representing the same type of mineral deposit, the data analysis for the known mineralized zones may include combined data for some or all such known mineralized zones or may contain data for a selected one of these known mineralized zones, which may be selected on the basis of size or the amount of data available. Similarly, the data analysis of known barren zones may include data from one or more known barren zones within the area of interest.

Where an area of interest contains known mineralized zones representing two or more types of mineral deposits, the data for these zones of differing mineral content are analyzed separately. Thus, the data analysis can be made specific to various types of mineral deposits.

The result of these analyses is the creation of three digital databases, a first for the area of interest as a whole, a second representing one or more known mineralized zones within the area of interest, and a third representing one or more known barren zones within the area of interest.

Next, the permutation and correlation analyses as described above with reference to FIGS. 4 to 6 is carried out for all three databases. Following this step, separate plots are generated for the parameters in the known mineralized zone and the known barren zone as described above with reference to FIGS. 7 and 8, and correlation coefficients are generated for the known mineralized zone and the known barren zone as described above.

For the purpose of illustration, let us assume that the correlation analysis of the known mineralized zone shows that W is directly proportional to E and T, and is inversely proportional to R, Y and U, then the relationship among these parameters (i.e. the “correlation coefficient”) for the known mineralized zone may be written as:

correlation coefficient (mineralized zone): WET/RYU.

Let us also assume that the correlation coefficient for the known barren zone is the following:

correlation coefficient (barren zone): WRTU/EY.

Next, the correlation coefficients for the mineralized and barren zones are compared to determine how the relationship of the parameters differs between the two zones. This involves modifying the correlation coefficient for the mineralized zone by eliminating any parameters that behave similarly in both groups. In the example presented above, this calculation comprises eliminating W and T from the numerator of the correlation coefficient for the mineralized zone since these parameters also appear in the numerator of the correlation coefficient for the barren zone; and by eliminating Y from the denominator of the correlation coefficient for the mineralized zone since this parameter also appears in the denominator of the correlation coefficient for the barren zone. This process results in the following combined correlation coefficient (referred to as the “range correlation coefficient ” or “RCC”) representing a relationship of parameters in the mineralized zone which is not present in the barren zone:

RCC (mineralized zone): E/RU.

The above RCC comprises the integrated effect of all the parameters at the same time, and represents an anomalous relationship of parameters which would be expected to be seen in other mineralized zones in the area of interest.

The next step is to apply the RCC to the area of interest and locate other zones where the relationship of parameters is consistent with the RCC for the known mineralized zone. Once such zones are identified, they can then be transferred to a map of the area of interest to represent potential mineralized areas.

As mentioned above, the method of the present invention preferably includes the performance of a permutation analysis prior to the correlation analysis. The permutation analysis provides additional parameters which are representative of various combinations of the individual parameters originally derived from the data. However, rather than following this sequence of steps it may be preferred to first perform a correlation analysis on the individual parameters. If strong correlations are seen in this data, then the correlation coefficients could be calculated directly from this data and the permutation analysis is unnecessary.

Although the method described above in the first and second preferred embodiments is sufficient to provide a map showing the location of mineralized target areas within the area of interest, additional steps can optionally be added to the method to further improve the chance of locating mineralized zones within the area of interest.

One such optional step is to combine the map of the mineralized target areas with other types of data. For example, it may be preferred to superimpose the map of potential mineralized target areas on a geological map of the area of interest. Such a map can be generated using software such as SURFER. This results in a composite map which shows the relation between the geology of the area of interest and the anomalies represented by the map of potential mineralized target areas, thus allowing the target areas to be ranked according to the likelihood that they contain mineral deposits.

For similar reasons, the map of potential mineralized target areas may preferably be combined with other maps showing, for example, the main tectonic features, the most probable distribution of mineralized zones, and/or the location of known mineralized zones within the area of interest. Furthermore, any of these composite maps may preferably be compiled and superimposed on an aerial or satellite photo to aid in determining the location of mineralized targets in the area of interest,

Other types of data analysis can also be combined with the map of potential mineralized target areas to assist in selecting which target areas should be explored first. One such analysis comprises a binomial analysis of the spatial distribution of known mineralization in order to determine if the distribution is casual and, it it is not casual, to determine the most probable direction (trend) of mineralization in the area, as well as the probable epicentres of mineralization.

Another such analysis comprises analysis of satellite imagery. if available, using ENVI, NUMAMET and /or other imagery systems. The main objective of this analysis is to collect additional information on zones of alteration, petrological units, etc.

Another analysis comprises the use of claim maps to eliminate target areas that are already claimed and to check the status of existing claims and their expiration dates.

The ore potential of the target areas can be further verified by comparing the map of potential mineralized target areas with results of drill hole analyses, geochemical surveys, etc. These should be among the data which was collected at the beginning of the process.

Other types of analysis which can be used to verify the existence of deposits in the target areas include testing for a relationship between target areas and geological objects using binomial tests, and geological reconnaissance of the target areas which may be combined with limited geochemical and geological sampling. However, it will be understood that the additional types of analysis described in this paragraph and in preceding paragraphs serve only to verify the results of the method of the invention and to rank potential mineralized target areas. These additional analyses do not otherwise modify the results of the method of the invention.

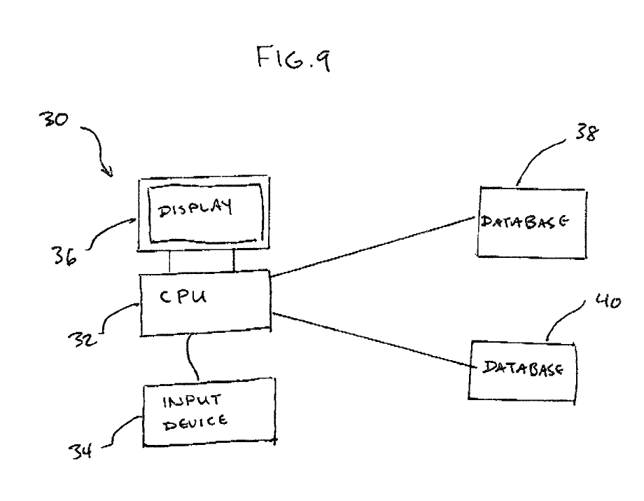

FIG. 9 represents a preferred apparatus 30 according to the invention, comprising a central processing unit (CPU) 32, an input device 34, for example a keyboard, for inputting data into the CPU, a display 36 and at least two databases 38 and 40 in which data is stored and processed. Database 38 in FIG. 9 represents the database table containing values for the parameters of which FIG. 3 is an example, and database 40 represents a database table containing values for the correlations as illustrated in FIGS. 4 and 5. Apparatus 30 may optionally include additional databases.

Although the method of the present invention has been described in relation to certain preferred embodiments, it is not intended to be limited thereto. Rather, the invention includes all embodiments which may fall within the scope of the following claims.

What is claimed is:

1. A method for locating a mineral deposit in an area of interest, comprising:
(a) gathering data relevant to the existence of the mineral deposit within the area of interest;
(b) analyzing said data and identifying a plurality of parameters present in said data;
(c) dividing the area of interest into a grid comprised of a plurality of grid elements;
(d) assigning a numerical value for each said parameter to each said grid element in said area of interest;
(e) calculating a plurality of correlation values, each one of said correlation values comprising a numerical value representative of a strength of a positive or negative correlation between one pair of said parameters over said area of interest;
(f) analyzing the correlation values to identify a correlation relationship between a subset of said plurality of parameters which show strong positive or negative correlations to one another,
(g) determining whether or not the correlation relationship is consistent with the data gathered for the area of interest; and
(h) where the correlation relationship is consistent with the data, identifying potential mineralized zones within said area of interest where the relationship between the parameters is consistent with the correlation relationship; or
(i) where the correlation relationship is not consistent with the data, returning to said step (f).

2. The method of claim 1, wherein the area of interest has an area of at least 500 km².

3. The method of claim 1, wherein said data is at least one member of the group comprising topographic maps, aerial photographs, satellite photographs, mining claim maps, digital elevation models, geological maps, drilling results and geophysical, geochemical, hydrogeological, geomorphological, biogeochemical and geobotanical information.

4. The method of claim 3, wherein said data is at least one member of the group comprising topographic maps, aerial photographs and satellite photographs.

5. The method of claim 4, wherein said step (b) includes analyzing said data to identify the location of lineaments in said area of interest, each type of lineament comprising one of said parameters.

6. The method of claim 5, wherein said numerical value assigned to each said parameter in said step (d) is representative of the number of a type of lineament in one of said grid elements.

7. The method of claim 1, wherein each of said grid elements has an area of about 1 km².

8. The method of claim 1 wherein said parameters include individual parameters derived from said data and combined parameters which are obtained by adding or multiplying all possible combinations of said individual parameters.

9. The method of claim 1, wherein said correlation values are calculated by the following formula:
r=(Xᵢ−Mₓ)(Yᵢ−M_{y})/((n−1)SₓS_{y})
wherein,
r is the correlation value;
Xᵢ is the value of parameter X for the ith grid element;
Mₓ is the average value of parameter X over all the grid elements;
Yᵢ is the value of parameter Y for the ith grid element;
M_{y} the average value of parameter Y over all the grid elements;
n is the number of data points for X and Y, and is equal to the number of grid elements;
Sₓ is the standard deviation for the parameter X; and
S_{y} is the standard deviation for the parameter Y.

10. The method of claim 1, wherein said step (f) includes ranking the correlation values from a maximum positive correlation value to a maximum negative correlation value, and eliminating correlation values representing weak correlations.

11. The method of claim 10, wherein said weak correlations are eliminated by dividing the correlation values into five equal groups representing strong positive correlations, medium positive correlations, weak positive and negative correlations, medium negative correlations and strong negative correlations, and eliminating the weak positive and negative correlations from further consideration.

12. The method of claim 1, wherein identification of the correlation relationship in said step (f) comprises converting each of the correlation values to a distance, and creating a plot of said parameters relative to one another wherein a separation between a pair of said parameters is proportional to said distance.

13. The method of claim 12, wherein said distance is calculated as follows:
Lᵢ =n+(1 −(rᵢ/rₘₐₓ))
wherein
Lᵢ is the calculated distance between the ith pair of parameters;
n is a minimum distance between any pair of parameters;
rᵢ is the correlation value for the ith pair of parameters; and
rₘₐₓ is a maximum correlation value between any pair of parameters.

14. The method of claim 1, additionally comprising the step of analyzing the data to identify the location of a known mineralized zone and a known barren zone within the area of interest.

15. The method of claim 14, wherein said steps (c) to (h) are conducted for said known mineralized zone and said known barren zone.

16. The method of claim 1, wherein said steps (e) and (f) are performed by a computer, and wherein said step (d) includes tabulation of the numerical values for each said parameter in each said grid element in an electronic database.

17. A system for locating a mineral deposit in an area of interest, comprising:
(a) data gathering means for gathering data relevant to the existence of the mineral deposit within the area of interest;
(b) first data analysis means for analyzing said data and identifying a plurality of parameters present in said data;
(c) first data tabulating means for tabulating numerical values of said plurality of parameters over said area of interest, wherein said area of interest is divided into a grid comprised of a plurality of grid elements and each said parameter is assigned a numerical value for each said grid element;
(d) data processing means for calculating a plurality of correlation values, each one of said correlation values comprising a numerical value representative of a strength of a positive or negative correlation between one pair of said parameters over said area of interest;
(e) second data analysis means for analyzing the correlation values and identifying a correlation relationship between a subset of said plurality of parameters which show strong positive or negative correlations to one another; and
(f) comparing means to determine whether or not the correlation relationship is consistent with the data gathered for the area of interest.

18. The system of claim 17, further comprising second data tabulating means for tabulating said correlation values calculated by the data processing means.
